(19) United States
(12) Patent Application Publication
(10) Pub. No.: US 2016/0117456 A1
(43) Pub. Date: Apr. 28, 2016

(54) Criteria Conditional Override Based on Patient Information and Supporting Evidence

(71) Applicant: International Business Machines Corporation, Armonk, NY (US)

(72) Inventors: Corville O. Allen, Morrisville, NC (US); Johanna M. Cook, Raleigh, NC (US); Andrew R. Freed, Cary, NC (US)

(73) Assignee: International Business Machines Corporation, Armonk, NY (US)

(21) Appl. No.: 14/524,536

(22) Filed: Oct. 27, 2014

(51) Int. Cl. G06F 19/00

(52) U.S. Cl. CPC G06F 19/345; G06F 19/363

(57) ABSTRACT

A method, system and computer-usable medium are disclosed for conditionally overriding strict criteria for a prospective medical treatment. Criteria for answering a question are received by a Question/Answer (QA) system, wherein the question is associated with a proposed medical treatment and the criteria are associated with a first condition. A second condition affecting the first condition is identified, which results in a modification to the first condition when it is determined that the second condition exceeds a predetermined threshold.

### BACKGROUND OF THE INVENTION

1. Field of the Invention

The present invention relates in general to the field of computers and similar technologies, and in particular to software utilized in this field. Still more particularly, it relates to a method, system and computer-usable medium for conditionally overriding strict criteria for a prospective medical treatment.

2. Description of the Related Art

When patients are seen, treated, or tested by medical practitioners and clinicians, the events of the interaction are recorded and become part of the patient's medical records. Maintenance of such medical records is an important element of modern medical treatment. Recently, the technology used for recording and archiving medical records has been undergoing an evolution. Modern medical and health care institutions are now adopting electronic medical records systems instead of traditional paper recording systems. Such computerized record keeping systems offer significant advantages to the practitioners, the patient, and the healthcare system as a whole.

Many medical and healthcare institutions also maintain a set of treatment guidelines for the benefit of health care providers. Such guidelines typically include established criteria to assist healthcare providers in their treatment of medical conditions. The criteria associated with these guidelines are typically the product of long-term clinical studies, the results of which are peer reviewed and published in established medical journals. As a result, the development of treatment guidelines for various diseases or ailments can be a complex and expensive process that is typically undertaken for a necessarily limited number of conditions.

Furthermore, the process may result in a constrained set of strict criteria for the treatment to be used for a given medical condition. As an example, a prospective treatment may have a certain strict criteria, or require a particular value for a criteria attribute, such as the patient being less than 60 years of age. While the reasons for the condition being strict are sometimes explicit, they sometimes vary, either based upon attributes associated with the patient or various aspects of the prospective treatment. Likewise, evidence may exist within the medical corpora that some conditions would override the strict condition and make it less strict. However, such exceptions are typically neither explained in detail nor included in the treatment guideline.

However, it is not uncommon for a patient to present with a set of symptoms or other indications that are not a perfect fit to a treatment guideline's criteria. When this occurs, the physician must often rely on his or her professional judgment to bridge the gap to determine whether, and to what extent, the criteria of the treatment guidelines actually apply. Such determinations often become more challenging as more vagaries in human physiology become measurable and part of the consideration. Furthermore, other aspects of the patient's health, such as their age, muscular condition, body mass index (BMI), diet, consumption of tobacco and alcohol, other current treatments, and so forth can make the determination of the applicability of a given treatment plan for a specific individual increasingly complex.

### SUMMARY OF THE INVENTION

A method, system and computer-usable medium are disclosed for conditionally overriding strict criteria for a prospective medical treatment. In various embodiments, criteria for answering a question are received by a Question/Answer (QA) system. In these embodiments, the criteria are associated with a first condition. A second condition affecting the first condition is identified, which results in a modification to the first condition when it is determined that the second condition exceeds a predetermined threshold.

In various embodiments, the question is associated with a prospective treatment for a medical condition. In these and other embodiments, the first condition is a numerical value and the second condition is a factor affecting the prospective treatment associated with the medical condition. In certain embodiments, the prospective treatment is determined to improve results for the prospective treatment. In various embodiments, the modification of the first condition results in a first evaluation of the prospective treatment being changed to a second evaluation. In certain embodiments, the second evaluation is the opposite of the first evaluation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an information handling system capable of performing computing operations;

FIG. 3 is a simplified block diagram of a criteria conditional override system; and

FIG. 4 is a generalized flowchart of the performance of criteria conditional override operations.

### DETAILED DESCRIPTION

A method, system and computer-usable medium are disclosed for conditionally overriding strict criteria for a prospective medical treatment. The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

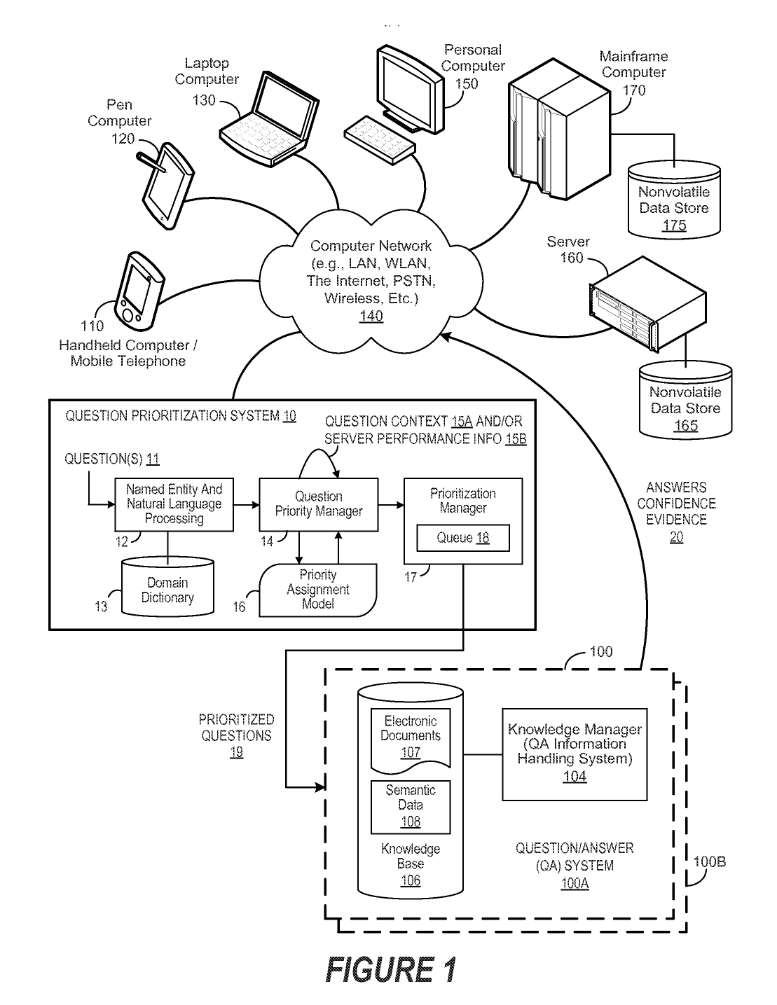

FIG. 1 depicts a schematic diagram of one illustrative embodiment of a question prioritization system 10 and question/answer (QA) system 100 connected to a computer network 140. The QA system 100 includes a knowledge manager 104 that is connected to a knowledge base 106 and configured to provide question/answer (QA) generation functionality for one or more content users who submit across the network 140 to the QA system 100. To assist with efficient sorting and presentation of questions to the QA system 100, the prioritization system 10 may be connected to the computer network 140 to receive user questions, and may include a plurality of subsystems which interact with cognitive systems, like the knowledge manager 100, to prioritize questions or requests being submitted to the knowledge manager 100.

The Named Entity subsystem 12 receives and processes each question 11 by using natural language (NL) processing to analyze each question and extract question topic information contained in the question, such as named entities, phrases, urgent terms, and/or other specified terms which are stored in one or more domain entity dictionaries 13. By leveraging a plurality of pluggable domain dictionaries relating to different domains or areas (e.g., travel, healthcare, electronics, game shows, financial services), the domain dictionary 11 enables critical and urgent words (e.g., “threat level”) from different domains (e.g., “travel”) to be identified in each question based on their presence in the domain dictionary 11. To this end, the Named Entity subsystem 12 may use a Natural Language Processing (NLP) routine to identify the question topic information in each question. As used herein. “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input. For example, NLP can be used to derive meaning from a human-oriented question such as, “What is tallest mountain in North America?” and to identify specified terms, such as named entities, phrases, or urgent terms contained in the question. The process identifies key terms and attributes in the question and compares the identified terms to the stored terms in the domain dictionary 13.

The Question Priority Manager subsystem 14 performs additional processing on each question to extract question context information 15A. In addition or in the alternative, the Question Priority Manager subsystem 14 may also extract server performance information 15B for the question prioritization system 10 and/or QA system 100. In selected embodiments, the extracted question context information 15A may include data that identifies the user context and location when the question was submitted or received. For example, the extracted question context information 15A may include data that identifies the user who submitted the question (e.g., through login credentials), the device or computer which sent the question, the channel over which the question was submitted, the location of the user or device that sent the question, any special interest location indicator (e.g., hospital, public-safety answering point, etc.), or other context-related data for the question. The Question Priority Manager subsystem 14 may also determine or extract selected server performance data 15B for the processing of each question. In selected embodiments, the server performance information 15B may include operational metric data relating to the available processing resources at the question prioritization system 10 and/or QA system 100, such as operational or run-time data, CPU utilization data, available disk space data, bandwidth utilization data, etc. As part of the extracted information 15A/B, the Question Priority Manager subsystem 14 may identify the SLA or QoS processing requirements that apply to the question being analyzed, the history of analysis and feedback for the question or submitting user, and the like. Using the question topic information and extracted question context and/or server performance information, the Question Priority Manager subsystem 14 is configured to populate feature values for the Priority Assignment Model 16 which provides a machine learning predictive model for generating a target priority values for the question, such as by using an artificial intelligence (AI) rule-based logic to determine and assign a question urgency value to each question for purposes of prioritizing the response processing of each question by the QA system 100.

The Prioritization Manager subsystem 17 performs additional sort or rank processing to organize the received questions based on at least the associated target priority values such that high priority questions are put to the front of a prioritized question queue 18 for output as prioritized questions 19. In the question queue 18 of the Prioritization Manager subsystem 17, the highest priority question is placed at the front for delivery to the assigned QA system 100. In selected embodiments, the prioritized questions 19 from the Prioritization Manager subsystem 17 that have a specified target priority value may be assigned to a specific pipeline (e.g., QA System 100A) in the QA system cluster 100. As will be appreciated, the Prioritization Manager subsystem 17 may use the question queue 18 as a message queue to provide an asynchronous communications protocol for delivering prioritized questions 19 to the QA system 100 such that the Prioritization Manager subsystem 17 and QA system 100 do not need to interact with a question queue 18 at the same time by storing prioritized questions in the question queue 18 until the QA system 100 retrieves them. In this way, a wider asynchronous network supports the passing of prioritized questions as messages between different computer systems 100A, 100B, connecting multiple applications and multiple operating systems. Messages can also be passed from queue to queue in order for a message to reach the ultimate desired recipient. An example of a commercial implementation of such messaging software is IBM's WebSphere MQ (previously MQ Series). In selected embodiments, the organizational function of the Prioritization Manager subsystem 17 may be configured to convert over-subscribing questions into asynchronous responses, even if they were asked in a synchronized fashion.

The QA system 100 may include one or more QA system pipelines 100A, 100B, each of which includes a computing device 104 (comprising one or more processors and one or more memories, and potentially any other computing device elements generally known in the art including buses, storage devices, communication interfaces, and the like) for processing questions received over the network 140 from one or more users at computing devices (e.g., 110, 120, 130) connected over the network 140 for communication with each other and with other devices or components via one or more wired and/or wireless data communication links, where each communication link may comprise one or more of wires, routers, switches, transmitters, receivers, or the like. In this networked arrangement, the QA system 100 and network 140 may enable question/answer (QA) generation functionality for one or more content users. Other embodiments of QA system 100 may be used with components, systems, sub-systems, and/or devices other than those that are depicted herein.

In each QA system pipeline 100A, 100B, a prioritized question 19 is received and prioritized for processing to generate an answer 20. In sequence, prioritized questions 19 are dequeued from the shared question queue 18, from which they are de-queued by the pipeline instances for processing in priority order rather than insertion order. In selected embodiments, the question queue 18 may be implemented based on a “priority heap” data structure. During processing within a QA system pipeline (e.g., 100A), questions may be split into many subtasks which run concurrently. A single pipeline instance can process a number of questions concurrently, but only a certain number of subtasks. In addition, each QA system pipeline may include a prioritized queue (not shown) to manage the processing order of these subtasks, with the top-level priority corresponding to the time that the corresponding question started (earliest has highest priority). However, it will be appreciated that such internal prioritization within each QA system pipeline may be augmented by the external target priority values generated for each question by the Question Priority Manager subsystem 14 to take precedence or ranking priority over the question start time. In this way, more important or higher priority questions can “fast track” through the QA system pipeline if it is busy with already-running questions.

In the QA system 100, the knowledge manager 104 may be configured to receive inputs from various sources. For example, knowledge manager 104 may receive input from the question prioritization system 10, network 140, a knowledge base or corpus of electronic documents 106 or other data, a content creator 108, content users, and other possible sources of input. In selected embodiments, some or all of the inputs to knowledge manager 104 may be routed through the network 140 and/or the question prioritization system 10. The various computing devices (e.g., 110, 120, 130, 150, 160, 170) on the network 140 may include access points for content creators and content users. Some of the computing devices may include devices for a database storing the corpus of data as the body of information used by the knowledge manager 104 to generate answers to cases. The network 140 may include local network connections and remote connections in various embodiments, such that knowledge manager 104 may operate in environments of any size, including local and global, e.g., the Internet. Additionally, knowledge manager 104 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 104. The document 106 may include any file, text, article, or source of data (e.g., scholarly articles, dictionary definitions, encyclopedia references, and the like) for use in knowledge manager 104. Content users may access knowledge manager 104 via a network connection or an Internet connection to the network 140, and may input questions to knowledge manager 104 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 104 may interpret the question and provide a response to the content user containing one or more answers to the question. In some embodiments, knowledge manager 104 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input prioritized question 19 and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 100 then generates an output response or answer 20 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

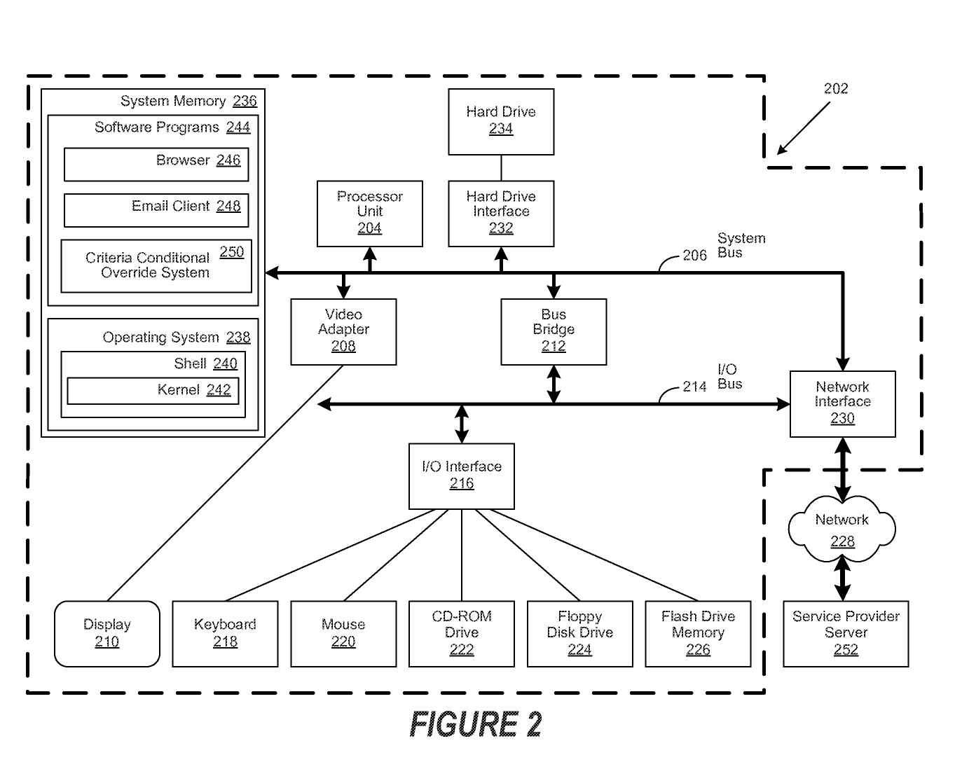

Types of information processing systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information processing systems include pen, or tablet, computer 120, laptop, or notebook, computer 130, personal computer system 150, and server 160. As shown, the various information processing systems can be networked together using computer network 140. Types of computer network 140 that can be used to interconnect the various information processing systems include Local Area Networks (LANs), Wireless Local Area Networks (WLANs), the Internet, the Public Switched Telephone Network (PSTN), other wireless networks, and any other network topology that can be used to interconnect the information processing systems. Many of the information processing systems include nonvolatile data stores, such as hard drives and/or nonvolatile memory. Some of the information processing systems may use separate nonvolatile data stores (e.g., server 160 utilizes nonvolatile data store 165, and mainframe computer 170 utilizes nonvolatile data store 175). The nonvolatile data store can be a component that is external to the various information processing systems or can be internal to one of the information processing systems. An illustrative example of an information processing system showing an exemplary processor and various components commonly accessed by the processor is shown in FIG. 2.

FIG. 2 illustrates an information processing system 202, more particularly, a processor and common components, which is a simplified example of a computer system capable of performing the computing operations described herein. Information processing system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information processing system 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing system 202) to send and receive network messages to the Internet using HyperText Transfer Protocol (HTTP) messaging, thus enabling communication with service provider server 252. In various embodiments, software programs 244 may also include a criteria conditional override system 250. In these and other embodiments, the criteria conditional override system 250 includes code for implementing the processes described hereinbelow. In one embodiment, information processing system 202 is able to download the criteria conditional override system 250 from a service provider server 252.

The hardware elements depicted in the information processing system 202 are not intended to be exhaustive, but rather are representative to highlight components used by the present invention. For instance, the information processing system 202 may include alternate memory storage devices such as magnetic cassettes, Digital Versatile Disks (DVDs), Bernoulli cartridges, and the like. These and other variations are intended to be within the spirit, scope and intent of the present invention.

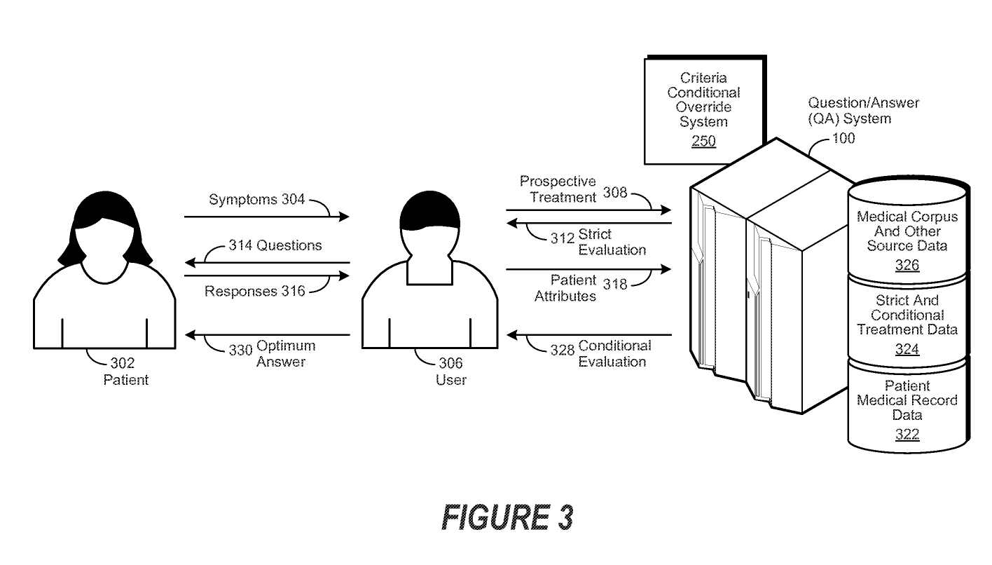

FIG. 3 is a simplified block diagram of a criteria conditional override system implemented in accordance with an embodiment of the invention. In various embodiments, strict criteria associated with guidelines for prospective treatment for a medical condition is overridden, based upon supporting evidence not found within the criteria. In these embodiments, the supporting evidence may include various attributes related to a patient's health or lifestyle. For example, the patient attributes may include their age, muscular condition, body mass index (BMI), diet, consumption of tobacco and alcohol, other current medical treatments, and so forth. As used herein, a strict criterion, as it relates to a prospective medical treatment, refers to an explicit treatment rule or principle. In certain embodiments, the strict criterion has an associated value, such as the patient must be less than 60 years of age, or have a BMI value that is greater than 19 and less than 25.

In various embodiments, a determination is made during evaluation of a patient's medical condition whether their condition should be treated as a strict evaluation or as a conditional evaluation. In these embodiments, medical and other data associated with the patient is acquired and processed to identify attributes that could result in a conditional evaluation. In certain of these embodiments, the identified patient attributes are then scored to determine whether predetermined parameters of the conditional evaluation are met or un-met. As used herein, a strict evaluation broadly refers to evaluating a patient's medical condition according to strict criteria, while a conditional evaluation broadly refers to evaluating the patient's medical condition according to associated conditions that result in the strict criteria being overridden by conditional criteria corresponding to the associated conditions.

In various embodiments, a candidate answer is received during a patient evaluation in response to a question based upon a predetermined strict criterion. A first confidence score, based upon the strict evaluation, is generated and associated with the candidate answer. In certain of these embodiments, the medical corpora and other sources are searched to identify a set of reasons that may result in the strict criterion becoming a conditional criterion. In these embodiments, the set of reasons are scored to determine whether they exceed a predetermined threshold of supporting evidence. If so, in the context of the question, a conditional evaluation is performed in addition to the strict evaluation.

In various embodiments, a second confidence score, based upon the conditional evaluation, is associated with the candidate answer. In certain embodiments, the conditional evaluation associated with the candidate answer is presented to a user, such as a medical practitioner or technician, in a set of optimum answers if its associated confidence score indicates that it exceeds the predetermined threshold of supporting evidence. In various embodiments, the user is provided the option of toggling between an answer's strict evaluation based on a set of strict criteria and a conditional evaluation based on a set of conditional criteria not found within the strict criteria, but from multiple sources or corpora instead.

Referring now to FIG. 3, criteria conditional override operations are begun in this embodiment by a patient 302 presenting with symptoms 304 of a predetermined medical condition to a user 306, such as a healthcare practitioner or technician. In response, the user 302 submits a prospective treatment 308 to a Question/Answer (QA) System 100, described in greater detail herein. In this embodiment, the QA system 100 includes a criteria conditional override system 250, and repositories of patient medical record data 322, strict and conditional treatment data 324, and medical corpus and other source data 326. It will be appreciated that in certain embodiments, the patient 302 may interact directly with the QA system 100. In certain embodiments when the patient 302 is interacting directly with the QA system 100 the questions and answers may be presented via a QA user interface (not shown).

The criteria conditional override system 250 then accesses the repository of strict and conditional treatment data 324 to retrieve strict criteria associated with the prospective treatment 308. The strict criteria is then processed by the criteria conditional override system 250 to generate a strict evaluation 312, which is then provided to the user 306. In certain embodiments, the strict evaluation 312 is used to perform a strict evaluation 312 of a sub-condition associated with the patient's 302 medical condition. Using the strict evaluation 312 as a baseline, the user 306 then provides questions 314 to the patient 302 and receives associated responses 316. In this and other embodiments, the questions 314 and responses 316 respectively provided and received by the user 306 results in a set of patient attributes 318 associated with the medical condition, which is then provided to the QA system 100 for processing. In various embodiments, the patient attributes 318 may include a strict numerical or an enumerated set of values.

As an example, the prospective treatment 308 for the patient 302 may be for Decitabine, which has associated strict criteria that includes the patient 302 being less than or equal to 60 years of age, having acute myeloid leukemia (AML), and no evidence of cardiac disease. In this example, the conditions for the patient 302 would be:

| | | |
|---|---|---|
| i) | Age <= 60 years = 69 | (NOT MET) |
| ii) | Patient has AML = AML | (MET) |
| iii) | Cardiac Disease = false | (MET) |

To continue the example, the strict criteria of the patient being less than or equal to 60 years of age is not met. However, according to various evidence sources, such as data stored in the repository of medical corpus and other source data 326, indicates that Decitabine is usually given if the patient is under 60 years old. However, the reason for the strict criteria associated with the patient's 302 age is that the patient 302 is usually not able to perform a series of light exercises that go well with the treatment regimen. However, there is supporting evidence of Decitabine being given when the patient is healthy, but sometimes slightly over the age. In this example, the patient has a performance status of ‘0’ according to the Zubrod scoring system, indicating that they are active and walking.

As a result, the set of conditional attributes for this attribute and treatment combination would conditionally be set as ‘MET’ because the patient attribute for the performance status evaluates it non-strictly because the patient can walk. In various embodiments, the set of conditional attributes associated with predetermined criteria is determined by a subject matter expert (SME), such as a medical practitioner or technician. In certain embodiments, the set of conditional attributes are discovered through data mining approaches known to skilled practitioners of the art. In these embodiments, the results of such data mining provides a set of evidence that supports giving the treatment in the cases where the condition is ‘MET,’ and in cases where the condition was ‘NOT MET.’ In various embodiments, based upon the patient's 302 medical condition, the set of evidence can be prescribed at design time by a data structure holding its conditional set of attributes, such as hidden sub-criteria. Skilled practitioners of the art will realize that many such examples and embodiments are possible and the foregoing is not intended to limit the spirit, scope or intent of the invention.

The criteria conditional override system 250 then processes the provided set of patient attributes 318 to determine treatment data associated with the medical condition, which is then retrieved from the repositories of strict and conditional treatment data 324 and medical corpus and other source data 326. The criteria conditional override system 250 then processes the set of patient attributes 318 and the treatment data associated with the medical condition to generate a conditional evaluation 328 for the medical condition. In various embodiments, the criteria conditional override system 250 additionally retrieves medical data related to the patient 302 from the repository of patient medical record data 322. In these embodiments, the medical data related to the patient 302 is processed along with the set of patient attributes 318 and the treatment data associated with the medical condition to generate a conditional evaluation 328 for the medical condition.

The previously-provided strict evaluation 312 and the resulting conditional evaluation 328 are then retained for use as a candidate answer, which is retained for subsequent processing. A determination is then made whether the final criteria evaluation would be changed by the conditional evaluation of the criteria, followed by retention of any resulting revisions to the strict evaluation 312 and any conditional evaluations 328. In certain embodiments, the resulting influence scores associated with the strict evaluation 312 and any conditional evaluations 328 are then used to generate candidate answers, which are likewise retained for subsequent processing.

In various embodiments, a determination is made whether the final criteria evaluation would be changed by the conditional evaluation 328 of the criteria. An optimum answer 330 is then generated from the candidate answers, which in turn is presented by the user 306 to the patient as a prescribed treatment of their medical condition. In various embodiments, the optimum answer 330 is a candidate answer that is augmented by the conditional evaluation 328. In certain of these embodiments, the candidate answer is augmented by the conditional evaluation 328 if its associated values exceeded a predetermined threshold of supporting evidence, as described in greater detail herein. In various embodiments, the optimum answer 330 is presented to the user 306 along with its associated criteria and conditionally assessed values.

In various embodiments, intelligent conditional overrides are implemented, based upon other factors associated with the patient 302, when performing the strict evaluation 312 and the conditional evaluation 328. In certain embodiments the conditional overrides are performed through the implementation of fuzzy logic approaches familiar to those of skill in the art. In various embodiments, various assumptions utilized in the performance of a conditional override may result in individual scores being boosted as a result of the inclusion of various criteria that have an associated higher weight.

As an example, the criteria associated with a target medical condition is treated fuzzily instead of strictly. In this example, various factors associated with the criteria are identified. To continue the example, it may be determined that the patient's 302 age is a less significant factor than suggested by the strict criteria, which states that the proposed treatment 308 should only be prescribed for patients less than 60 years of age, as they are more likely to be mobile, and so forth. However, this strict criteria can be overridden in when there is evidence that a 70 year old patient is in great health. In view of the foregoing, it will be appreciated that various embodiments of the invention provide a more malleable approach to evaluating various strict criteria to determine whether it can be overridden, which is more akin to how medical practitioners and technicians evaluate criteria.

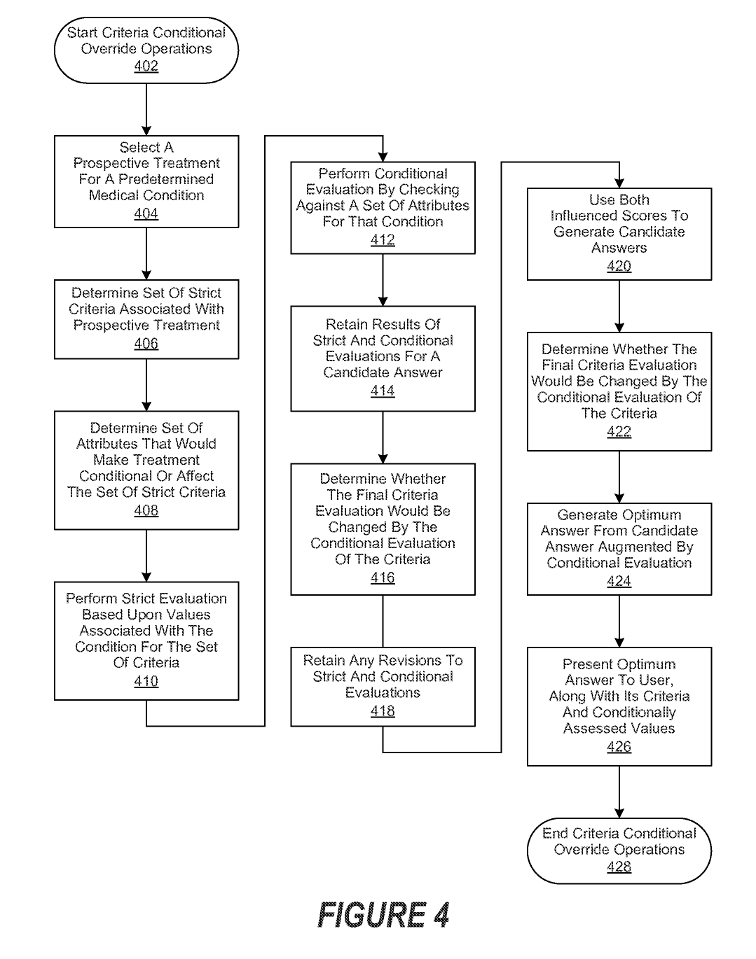

FIG. 4 is a generalized flowchart of criteria conditional override operations performed in accordance with an embodiment of the invention. In this embodiment, criteria conditional override operations are begun in step 402, followed by the selection of a prospective treatment for a predetermined medical condition in step 404. A set of strict criteria for the prospective treatment is then determined in step 406, followed by determining a set of attributes in step 408 that would either make the prospective medical treatment conditional or affect the set of strict criteria determined in step 406. In various embodiments, the set of attributes may include a strict numerical or an enumerated set of values for the medical condition.

Based upon the values associated with the medical condition, a strict evaluation is then performed in step 410, as described in greater detail herein, using the strict criteria determined in step 406. In certain embodiments, the strict criteria are used to perform a strict evaluation of a sub-condition of the medical condition. Then, in step 412, a conditional evaluation is performed, as likewise described in greater detail herein, by checking against a set of attributes for the medical condition.

The results of the strict and conditional evaluation are then retained in step 414 for use as a candidate answer. A determination is then made in step 416 whether the final criteria evaluation would be changed by the conditional evaluation of the criteria, followed by retention of any resulting revisions to the strict and conditional evaluations in step 418. The resulting influence scores, associated with the strict and conditional evaluations, are then used in step 420 to generate candidate answers.

A determination is then made in step 422 whether the final criteria evaluation would be changed by the conditional evaluation of the criteria. An optimum answer is then generated in step 424 from the candidate answers. In various embodiments, the optimum answer is a candidate answer that is augmented by the conditional evaluation. In certain of these embodiments, the candidate answer is augmented by the conditional evaluation if its associated values exceeded a predetermined threshold of supporting evidence, as described in greater detail herein. The optimum answer is then presented to the user in step 426, along with its associated criteria and conditionally assessed values. Criteria conditional override operations are then ended in step 428.

Although the present invention has been described in detail, it should be understood that various changes, substitutions and alterations can be made hereto without departing from the spirit and scope of the invention as defined by the appended claims.

1-8. (canceled)

9. A system comprising:
a processor,
a data bus coupled to the processor; and
a computer-usable medium embodying computer program code, the computer-usable medium being coupled to the data bus, the computer program code used for answering questions based upon conditional criteria and comprising instructions executable by the processor and configured for:
receiving criteria for answering a question, the criteria associated with a first condition and received by a system configured to answer questions;
identifying a second condition affecting the first condition; and
answering the question with a modification of the first condition, the answering performed in response to determining that the second condition exceeds a threshold.

10. The system of claim 9, wherein:
the question is a prospective treatment for a medical condition associated with a person.

11. The system of claim 9, wherein:
the first condition is a numerical value; and
the second condition is a factor affecting the prospective treatment associated with the first condition.

12. The system of claim 11, wherein:
the factor affecting the prospective treatment is determined to improve results for the prospective treatment.

13. The system of claim 9, wherein:
the modification of the first condition results in a first evaluation of the prospective treatment being changed to a second evaluation.

14. The system of claim 13, wherein:
the second evaluation is the opposite of the first evaluation.

15. A non-transitory, computer-readable storage medium embodying computer program code, the computer program code comprising computer executable instructions configured for:
receiving criteria for answering a question, the criteria associated with a first condition and received by a system configured to answer questions;
identifying a second condition affecting the first condition; and
answering the question with a modification of the first condition, the answering performed in response to determining that the second condition exceeds a threshold.

16. The non-transitory, computer-readable storage medium of claim 15, wherein:
the question is a prospective treatment for a medical condition associated with a person.

17. The non-transitory, computer-readable storage medium of claim 15, wherein:
the first condition is a numerical value; and
the second condition is a factor affecting the prospective treatment associated with the first condition.

18. The non-transitory, computer-readable storage medium of claim 17, wherein:
the factor affecting the prospective treatment is determined to improve results for the prospective treatment.

19. The non-transitory, computer-readable storage medium of claim 15, wherein:
the modification of the first condition results in a first evaluation of the prospective treatment being changed to a second evaluation.

20. The non-transitory, computer-readable storage medium of claim 19, wherein:
the second evaluation is the opposite of the first evaluation.
